(19) United States
(12) Patent Application Publication
(10) Pub. No.: US 2025/0088463 A1
(43) Pub. Date: Mar. 13, 2025

(54) TRAFFIC ENGINEERING DEVICE, TRAFFIC ENGINEERING METHOD, AND TRAFFIC ENGINEERING PROGRAM

(71) Applicant: Nippon Telegraph and Telephone Corporation, Tokyo (JP)

(72) Inventors: Masato NISHIGUCHI, Musashino-shi, Tokyo (JP); Takayuki FUJIWARA, Musashino-shi, Tokyo (JP); Satoshi NAKATSUKASA, Musashino-shi, Tokyo (JP); Yuki TAKEI, Musashino-shi, Tokyo (JP)

(21) Appl. No.: 18/728,510

(22) PCT Filed: Feb. 1, 2022
(86) PCT No.: PCT/JP2022/003891

§ 371 Date: Jul. 12, 2024

(51) Int. Cl. H04L 47/125

(52) U.S. Cl. CPC H04L 47/125

(57) ABSTRACT

An acquisition unit acquires network topology information indicating a connection form of a network device and traffic information data that is information about flows in traffic. A path calculation unit calculates a path of each flow so that the number of flows whose paths are to be changed is minimized.

### TECHNICAL FIELD

The present invention relates to a traffic engineering device, a traffic engineering method, and a traffic engineering program.

### BACKGROUND ART

Efficient accommodation of increasing traffic is an important issue for communication carriers. In the past, there has been known a technology called traffic engineering (TE) for calculating a traffic path in which the network resource utilization is minimized by solving a mathematical optimization problem including constraints such as network topology, link capacity, and AC traffic, and explicitly changing the traffic path (See Non Patent Literatures 1 and 2).

### CITATION LIST

### Non Patent Literature

Non Patent Literature 1: Masashi Hashimoto and 5 others, “Pasu saisettei torahikku ryo wo seigen kanouna doteki MPLS-TE shuho no teian to hyouka (in Japanese) (Proposal and evaluation of dynamic MPLS-TE method capable of limiting path resetting traffic volume”, The transactions of the Institute of Electronics, Information and Communication Engineers. B, The Institute of Electronics, Information and Communication Engineers (IEICE), 2008, Vol. J91-B No. 6, pp. 645-654
Non Patent Literature 2: Yufei Wang, Zheng Wang, [Explicit Routing Algorithms for Internet Traffic Engineering], IEEE. Proceedings Eight International Conference on Computer Communications and Networks (Cat. No. 99EX370)

### SUMMARY OF INVENTION

### Technical Problem

However, in the related art, it is difficult to limit or suppress communication being a target of path change on the basis of flow information, an operation policy, or the like. For example, in a system according to the related art, TE can only be performed in units of thick bundles such as in units of links due to a low resolution of traffic identification. In addition, there is no mechanism for detailed analysis of AC traffic information. Therefore, there is difficulty in path control through the detailed analysis of the traffic labeled/encapsulated in a multiple manner, followed by path calculation for suppressing re-routing and traffic identification on a fine granularity. In addition, it has been known that a large-scale network such as a communication carrier has difficulty in solving the problems within a realistic time.

The present invention has been contrived in view of the above circumstances, and an object thereof is to enable limitation or suppression of communication being a target of path change on the basis of flow information, an operation policy, or the like.

### Solution to Problem

In order to solve the above-described problems and achieve the object, a traffic engineering device according to the present invention includes: an acquisition unit that acquires information indicating a connection form of a network device and information about flows in traffic; and a path calculation unit that calculates a path of each flow so that the number of flows whose paths are to be changed is minimized.

### Advantageous Effects of Invention

According to the present invention, it is possible to limit or suppress communication being a target of path change on the basis of flow information, an operation policy, or the like.

### BRIEF DESCRIPTION OF DRAWINGS

FIG. 1 is a diagram for explaining an overview of a TE device.

FIG. 2 shows diagrams for explaining an overview of a TE device.

FIG. 3 is a diagram for explaining an overview of the TE device.

FIG. 4 is a diagram for explaining an overview of the TE device.

FIG. 5 is a schematic diagram illustrating a schematic configuration of the TE device.

FIG. 6 is a diagram illustrating a data configuration of network topology information.

FIG. 7 is a diagram illustrating a data configuration of traffic information data.

FIG. 8 is a diagram for explaining processing by a preprocessing unit.

FIG. 9 is a diagram for explaining processing by a TE device according to a first embodiment.

FIG. 10 is a diagram for explaining processing by the TE device according to the first embodiment.

FIG. 11 shows diagrams for explaining processing by the TE device according to the first embodiment.

FIG. 12 shows diagrams for explaining processing by the TE device according to the first embodiment.

FIG. 13 is a diagram for explaining processing by the TE device according to the first embodiment.

FIG. 14 shows diagrams for explaining processing by the TE device according to the first embodiment.

FIG. 15 shows diagrams for explaining processing by the TE device according to the first embodiment.

FIG. 16 shows diagrams for explaining processing by the TE device according to the first embodiment.

FIG. 17 shows diagrams for explaining processing by the TE device according to the first embodiment.

FIG. 18 is a diagram for explaining processing by the TE device according to the first embodiment.

FIG. 19 is a flowchart illustrating a procedure of the TE processing.

FIG. 20 is a diagram for explaining processing by a TE device according to a second embodiment.

FIG. 21 is a diagram for explaining processing by the TE device according to the second embodiment.

FIG. 22 is a diagram for explaining processing by a TE device according to a third embodiment.

FIG. 23 is a diagram for explaining processing by the TE device according to the third embodiment.

FIG. 24 is a diagram for explaining processing by a TE device according to another embodiment.

FIG. 25 is a diagram illustrating a computer that executes a TE program.

### DESCRIPTION OF EMBODIMENTS

Hereinafter, an embodiment of the present invention will be described in detail with reference to the drawings. Note that the present invention is not limited by this embodiment. Furthermore, in the description of the drawings, the same parts are denoted by the same reference numerals.

### [Overview of Traffic Engineering (TE) Device]

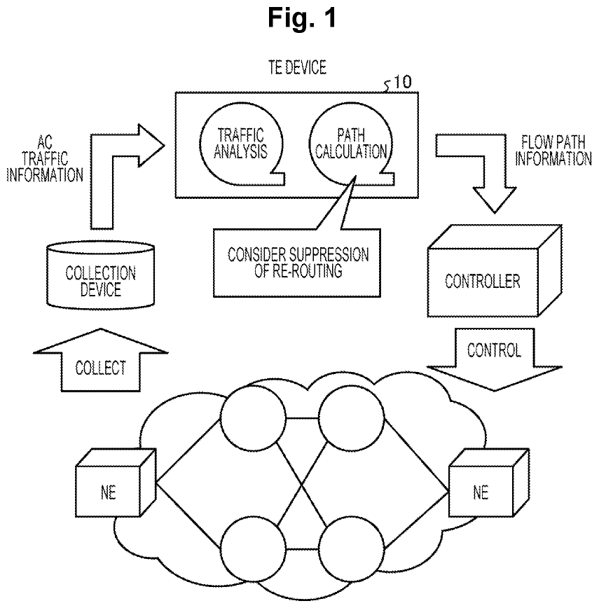

FIGS. 1 to 4 are diagrams for explaining an overview of a TE device. First, as illustrated in FIG. 1, a TE device 10 according to the present embodiment analyzes, from AC traffic information collected from a network element (NE), information, such as a service such as a VPN, user communication, and a communication path, and performs path calculation by which to suppress re-routing on the basis of the analyzed information.

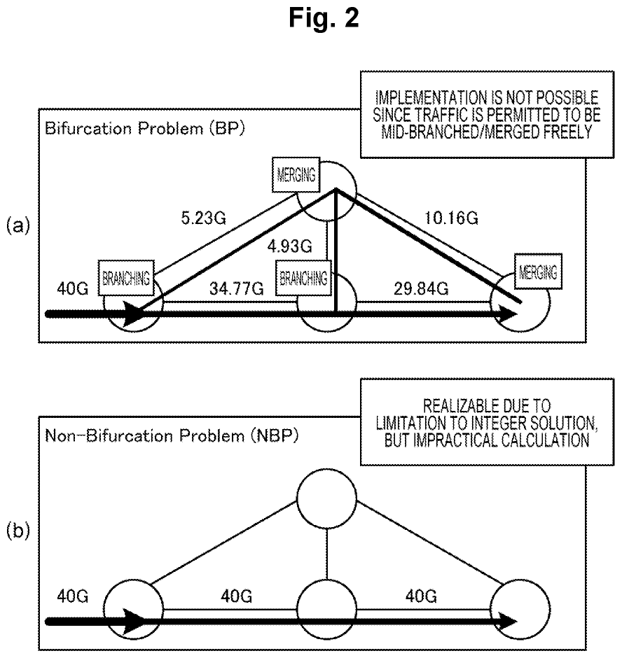

Here, in TE according to the related art, as illustrated in FIG. 2, there is classification into a bifurcation problem (BP) that allows mid-branching/merging of traffic and a non-bifurcation problem (NBP) that does not allow the mid-branching and merging. In the BP, as illustrated in FIG. 2(a), it is allowed that the solution of a mathematical optimization problem is a real number solution. Therefore, although the calculation is fast, there is difficulty in realizing mid-branching/merging of traffic by a real network device.

On the other hand, in the NBP, as illustrated in FIG. 2(b), the solution of a mathematical optimization problem is limited to an integer solution. Therefore, it has been known that although it is possible to realize the mid-branching and merging by a network device, finding the integer solution is NP-hard.

Therefore, in the TE device 10 according to the present embodiment, in path calculation, by using a heuristic method, paths are calculated so that no mid-branching/merging of traffic occurs within a realistic time, though they are not optimal solutions.

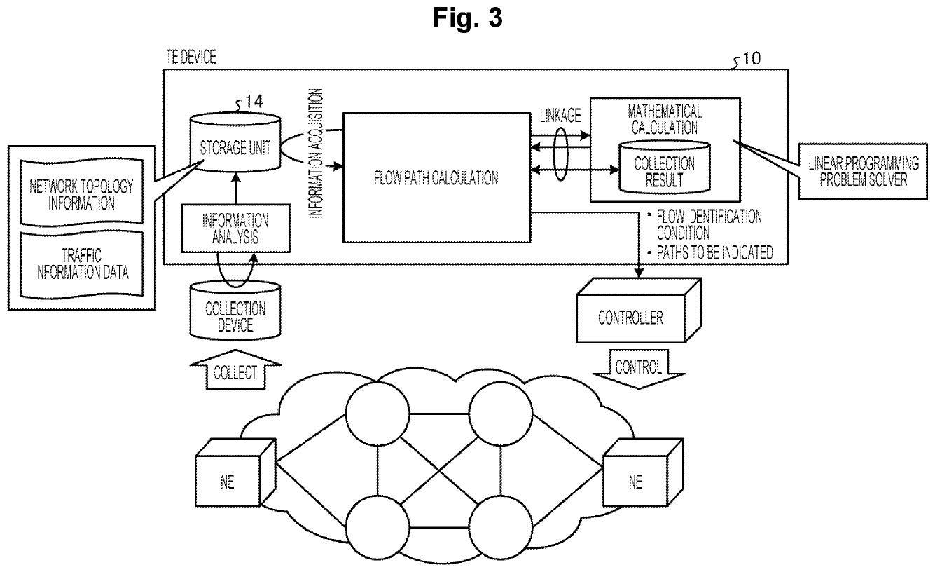

Specifically, as illustrated in FIG. 3, the TE device 10 analyzes the collected AC traffic information, acquires network topology information and traffic information data, and stores the network topology information and the traffic information data in a storage unit 14. Then, on the basis of the acquired network topology information and traffic information data, the TE device 10 performs path calculation by which to suppress flow re-routing.

In that case, as will be described later, the TE device 10 may perform path calculation by using an optimal solution that is a mathematical calculation result obtained by a linear programming problem solver. For example, the TE device 10 formulates a linear programming problem with the following objective variables, constraints, and variables by using the network topology information and the traffic information data, passes the linear programming problem to the linear programming problem solver, and receives a return of the resultant variable.

The objective variables of the linear programming problem are provided to minimize the maximum link utilization and minimize the flows whose paths are to be re-routed. In addition, the constraints are network topology, link capacity, and traffic volume/path information of the flows. In addition, the variable is a path through which the traffic of each flow should pass, and a real number solution is obtained.

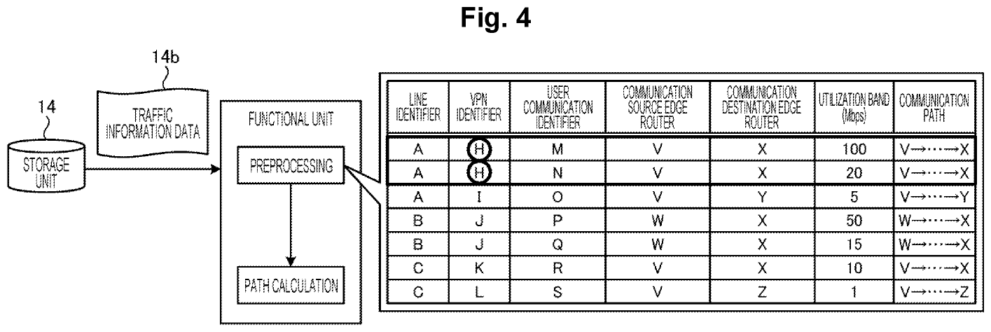

As illustrated in FIG. 4, before the path calculation, the TE device 10 performs preprocessing of deleting a flow whose path is to be not re-routed, to exclude the flow from path calculation targets. In the example illustrated in FIG. 4, a flow of a VPN identifier “H” indicating a service for a premium user is excluded from path calculation targets by deleting the flow from the traffic information data. Accordingly, re-routing can be efficiently suppressed.

### First Embodiment

### [Configuration of TE Device]

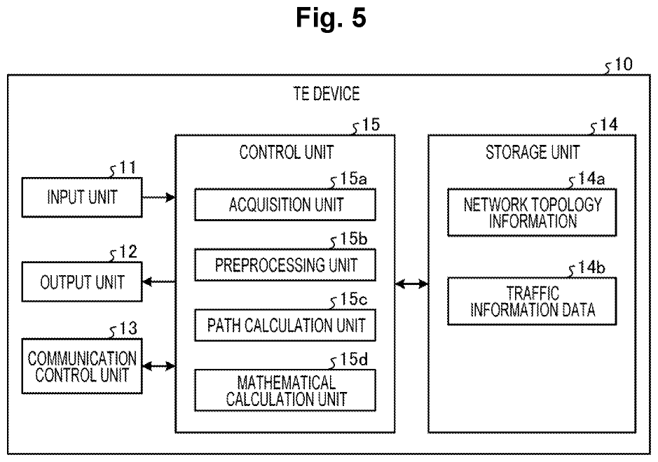

FIG. 5 is a schematic diagram illustrating a schematic configuration of the TE device. As illustrated in FIG. 5, the TE device 10 is realized by a general-purpose computer such as a personal computer, and includes an input unit 11, an output unit 12, a communication control unit 13, a storage unit 14, and a control unit 15.

The input unit 11 is realized by using an input device such as a keyboard or a mouse and inputs various types of instruction information such as processing start to the control unit 15 in response to an input operation of an operator. The output unit 12 is realized by a display device such as a liquid crystal display, a printing device such as a printer, or the like. For example, the output unit 12 displays a TE result to be described later.

The communication control unit 13 is realized by a network interface card (NIC) or the like and controls communication between an external device and the control unit 15 via an electric communication line such as a local area network (LAN) or the Internet. For example, the communication control unit 13 controls communication between the control unit 15 and an external device, such as a network device such as an edge router, a collection device that collects AC traffic information of the network device, or a controller that carries out TE.

The storage unit 14 is realized by a semiconductor memory element such as a random access memory (RAM) or a flash memory, or a storage device such as a hard disk or an optical disc. In the storage unit 14, a processing program for operating the TE device 10, data to be used during execution of the processing program, and the like are stored in advance or temporarily stored each time processing is performed.

In the present embodiment, in the storage unit 14, network topology information 14a, traffic information data 14b, and the like are stored. The storage unit 14 may communicate with the control unit 15 via the communication control unit 13.

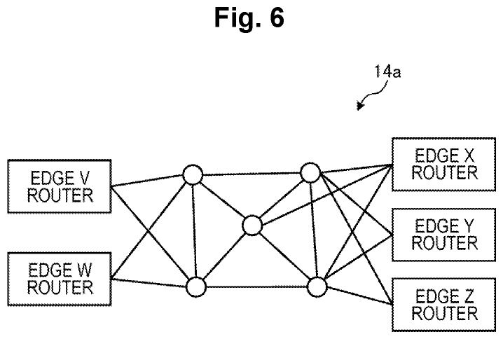

FIG. 6 is a diagram illustrating a data configuration of the network topology information. The network topology information 14a indicates a connection form of a network device (NE) such as an edge router. For example, as illustrated in FIG. 6, the network topology information 14a represents a link between NE and NE in graph format. V, W, X, Y, and Z illustrated in FIG. 6 are edge routers.

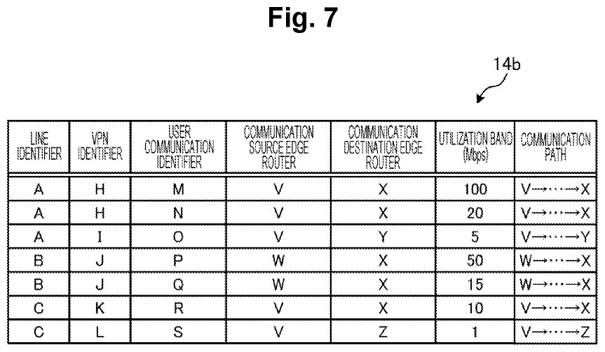

FIG. 7 is a diagram illustrating a data configuration of the traffic information data. As illustrated in FIG. 7, the traffic information data 14b includes information about line identifiers, VPN identifiers, user communication identifiers, communication source edge routers, communication destination edge routers, utilization bands, and communication paths of the flows. The line identifier is, for example, a VID of a C-VLAN. The VPN identifier is, for example, an outer IP address of a tunnel such as IPsec. The user communication identifier is an inner IP address of a tunnel.

The description returns to FIG. 5. The control unit 15 is realized by using a central processing unit (CPU), a network processor (NP), a field programmable gate array (FPGA), or the like and executes a processing program stored in the memory. Accordingly, the control unit 15 functions as an acquisition unit 15a, a preprocessing unit 15b, a path calculation unit 15c, and a mathematical calculation unit 15d as illustrated in FIG. 5. Each of these functional units may be implemented in different hardware. For example, the preprocessing unit 15b may be implemented in hardware different from other functional units. In addition, the control unit 15 may also include other functional units.

The acquisition unit 15a acquires the network topology information 14a indicating the connection form of the network device and the traffic information data 14b that is information about flows in traffic. For example, the acquisition unit 15a acquires AC traffic information from a collection device or the like that collects the AC traffic information via the communication control unit 13. In addition, the acquisition unit 15a analyzes the collected AC traffic information, and acquires the network topology information 14a and the traffic information data 14b. The acquisition unit 15a stores the acquired network topology information 14a and traffic information data 14b in the storage unit 14.

The preprocessing unit 15b deletes, from the traffic information data 14b that is the information about flows in traffic, information about a flow for which path change is not permitted. Specifically, the preprocessing unit 15b receives, via the input unit 11 or the communication control unit 13, an input designating a flow for which path change is not permitted, and deletes the designated flow from the traffic information data 14b.

For example, as illustrated in FIG. 4, the preprocessing unit 15b deletes a flow, whose path is to be not re-routed, of a service for a premium user or the like from the traffic information data 14b. Accordingly, the preprocessing unit 15b excludes the flow from TE processing targets to be described later.

In addition, the preprocessing unit 15b adds at least any of an average value, a maximum value, and a minimum value of traffic amounts acquired at different times to the traffic information data 14b that is the information about flows in traffic.

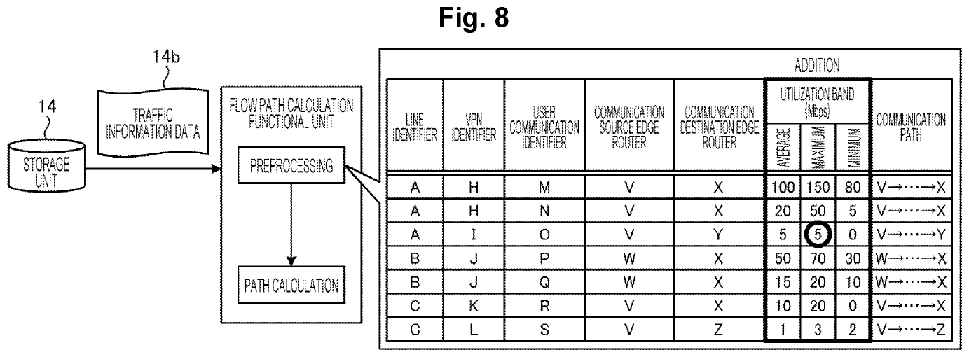

Here, FIG. 8 is a diagram for explaining processing by the preprocessing unit. In order to perform TE processing in consideration of the temporal fluctuation of traffic, as illustrated in FIG. 8, the preprocessing unit 15b may calculate an average value, a maximum value, and a minimum value in a band of each flow based on a plurality of pieces of data acquired at different times, and add the average value, the maximum value, and the minimum value to the traffic information data 14b.

Usually, since the band of a flow changes over time, a path calculated by cutting off traffic information at a certain time is not necessarily an optimal solution at different times. In contrast, in TE processing to be described later, it is possible to properly use the average value, the maximum value, or the minimum value as the band of each flow according to the availability of network resources or a policy. For example, in a case where the availability of network resources is large, or for a preferential flow, TE processing is performed using the maximum value of the utilization band.

The description returns to FIG. 5. The path calculation unit 15c calculates the path of each flow so that the number of flows whose paths are to be changed is minimized.

Specifically, in the TE device 10 according to the present embodiment, the mathematical calculation unit 15d calculates the solutions of the linear programming problem formulated so that the number of flows whose paths are to be changed is minimized and the maximum link utilization is minimized. In addition, the path calculation unit 15c determines the path of each flow on the basis of the solutions of the linear programming problem obtained with respect to flow groups generated by grouping the flows in traffic.

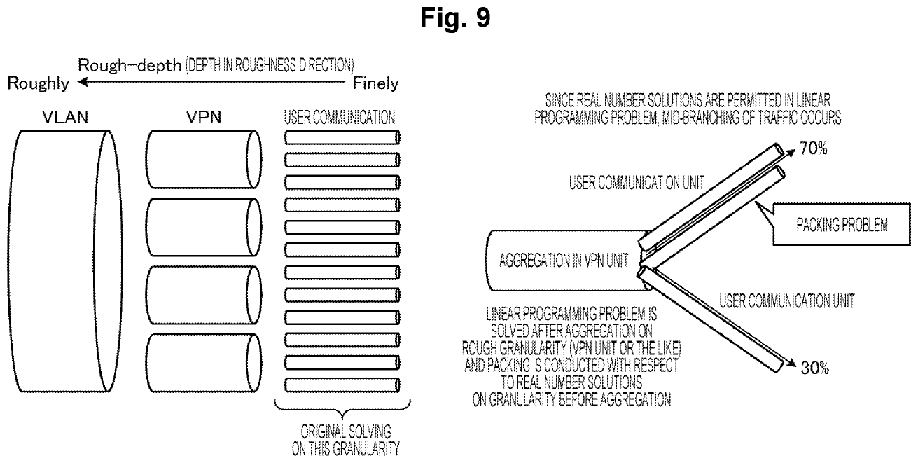

Here, FIGS. 9 to 18 are diagrams for explaining the processing by the TE device according to the first embodiment. First, as illustrated in FIG. 9, the path calculation unit 15c groups flows in original user communication unit into VPN unit, VLAN unit, or the like to create flow groups on a rough granularity. In addition, the mathematical calculation unit 15d solves the linear programming problem with respect to the flow groups aggregated on a rough granularity into VPN unit or the like.

Then, the path calculation unit 15c applies a packing problem of fitting each flow to the real number solutions. That is, by packing the flows in original user communication unit into the real number solutions in which mid-branching of traffic occurs, the real number solutions are realized. In the example illustrated in FIG. 8, the real number solutions branching the flows in VPN unit into 70% and 30% is realized by distributing the flows in user communication unit.

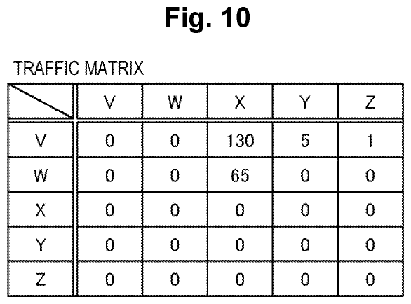

Specifically, the path calculation unit 15c aggregates the traffic information data 14b for each edge router, and creates a traffic matrix representing information between the edge routers as illustrated in FIG. 10. FIG. 10 illustrates the utilization band (Mbps) between the edge routers.

Next, the mathematical calculation unit 15d solves a linear programming problem that minimizes the maximum link utilization using the network topology information 14a and the traffic matrix, to calculate an optimal solution.

Regarding flows branched in the optimal solution, the path calculation unit 15c considers flows that cannot be accommodated in line unit to be accommodated in VPN unit. In addition, the path calculation unit 15c considers flows that cannot be accommodated in VPN unit to be accommodated in user communication unit. In addition, the path calculation unit 15c calculates paths of flows that cannot be accommodated in user communication unit by Dijkstra's algorithm.

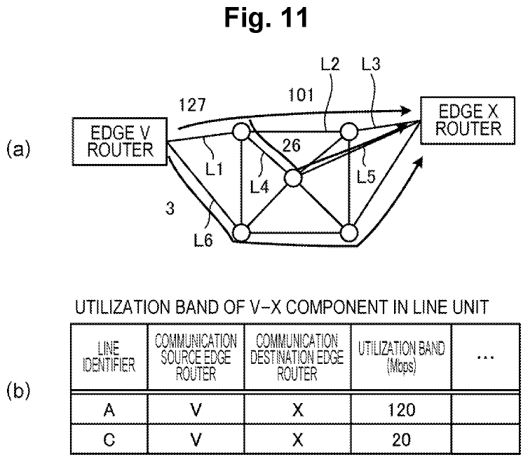

For example, in the examples illustrated in FIGS. 11 to 18, a flow (V-X flow) from an edge router V to an edge router X with a utilization band of 130 Mbps is a TE processing target in the traffic matrix illustrated in FIG. 10.

FIG. 11(a) illustrates the respective bands of links L1 to L6 in the optimal solution of the V-X flow. As described below, the band can be regarded as an upper limit value of the flow accommodated for each link by the path calculation unit 15c. For example, in the L1, a flow with a utilization band of up to 127 Mbps can be accommodated. The accommodation upper limit value may be multiplied by a parameter for adjustment to give relaxation. This makes it possible to avoid the occurrence of a flow that cannot be accommodated, as will be described later.

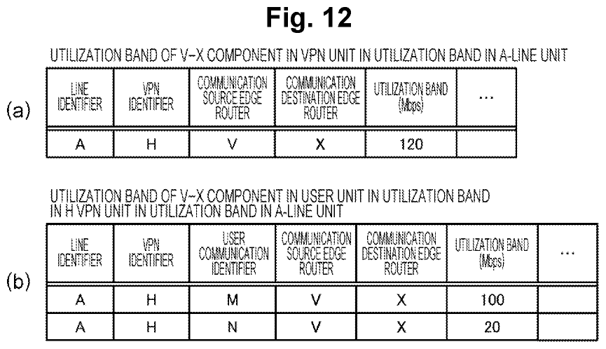

In addition, FIG. 11(b) illustrates a breakdown in line unit of the V-X flow of 130 Mbps. Similarly, FIGS. 12 to 17 each illustrate a breakdown in line unit, VNP unit, or user communication unit of the V-X flow.

The path calculation unit 15c selects the thickest link branching from the node at the start point of the target flow. In the example illustrated in FIG. 11(a), the link L1 is selected. In the link L1, a flow of up to 127 Mbps can be accommodated. The path calculation unit 15c accommodates the flows in line unit that can be accommodated in the above range in descending order of the utilization band by greedy algorithm. For example, a flow of a line identifier A with a utilization band of 120 Mbps illustrated in FIG. 11(b) is accommodated in the link L1.

Next, the path calculation unit 15c selects the thickest link L2 following the link L1 for the flow of the line identifier A. In the link L2, a flow of up to 101 Mbps can be accommodated. As illustrated in FIG. 12 (a), there are neither flows in line unit nor flows in VPN unit that can be accommodated in the above range. Therefore, the path calculation unit 15c accommodates the thickest flow of a user communication identifier M with a utilization band of 100 Mbps among the flows in user communication unit illustrated in FIG. 12 (b).

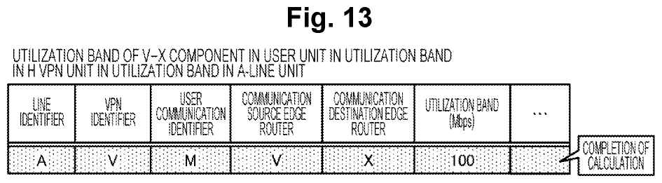

Next, the path calculation unit 15c selects the thickest link L3 following the link L2 for the flow of the user communication identifier M. In the link L3, a flow of up to 101 Mbps can be accommodated. As illustrated in FIG. 13, the path calculation unit 15c accommodates the flow of the user communication identifier M in the above range. In this case, the path calculation unit 15c returns flag information indicating that the accommodation of the flows of the user communication identifier M in user communication unit has been completed.

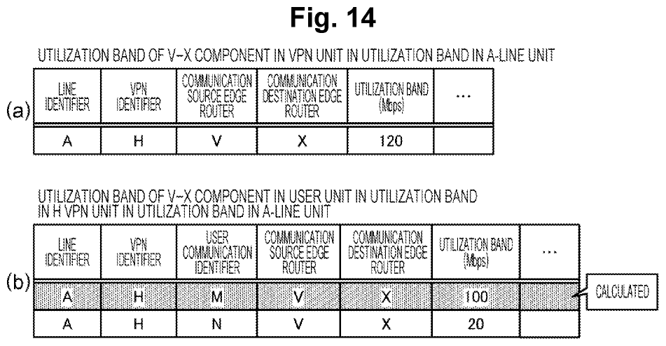

In addition, for flows not accommodated, the path calculation unit 15c returns the processing to the preceding step and updates the residual band in which the accommodation in the link L2 is possible to 1 Mbps that is a result obtained by subtracting 100 Mbps determined from 101 Mbps. A flow of a user communication identifier N not accommodated, illustrated in FIG. 14 (b), has a utilization band of 20 Mbps, and cannot be accommodated in the residual band of the link L2.

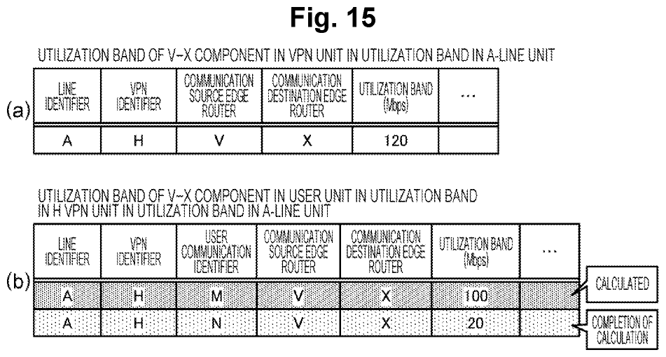

Therefore, the path calculation unit 15c selects the link L4 following the link L1 for the flow of the line identifier A. In the link L4, a flow of up to 26 Mbps can be accommodated, but as illustrated in FIG. 15(a), there is no flow in VPN unit that can be accommodated in the above range. Therefore, the path calculation unit 15c accommodates the flow of the user communication identifier N.

Next, the path calculation unit 15c selects the link L5 following the link L4 for the flow of the user communication identifier N. In the link L5, a flow of up to 26 Mbps can be accommodated. The path calculation unit 15c accommodates the flow of the user communication identifier N in the above range. In addition, as illustrated in FIG. 15(b), the path calculation unit 15c returns flag information indicating that the accommodation of the flows of the user communication identifier N in user communication unit has been completed.

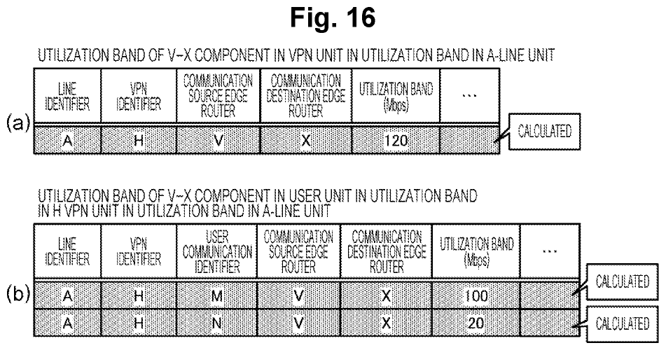

Next, for flows not accommodated, the path calculation unit 15c returns the processing to the preceding step and updates the residual band of the link L4 to 6 Mbps that is a result obtained by subtracting 20 Mbps determined from 26 Mbps. Meanwhile, as illustrated in FIG. 16(b), since there is no flow not accommodated, the path calculation unit 15c returns the processing to the further preceding step, and returns flag information indicating that the accommodation of the flows in VPN unit of the line identifier A has been completed as illustrated in FIG. 16(a).

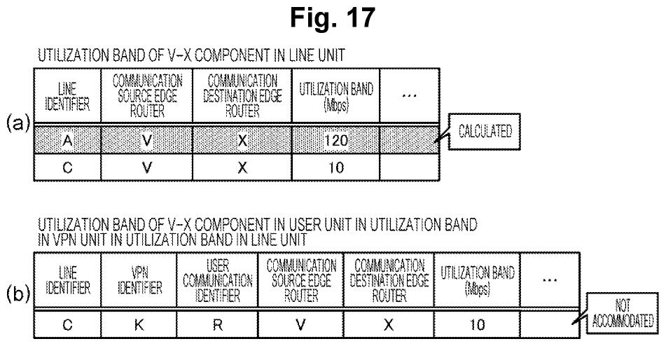

Next, the path calculation unit 15c selects the link L6 for a flow in line unit not accommodated. In the link L6, a flow of up to 3 Mbps can be accommodated, but as illustrated in FIG. 17 (a), there is no flow in line unit that can be accommodated in the above range. Here, as illustrated in FIG. 17 (b), a flow of a line identifier C not accommodated cannot be accommodated in both VPN unit and user communication unit. Therefore, the path calculation unit 15c returns information indicating that a flow of a user communication identifier R has not been accommodated, and completes the processing for the V-X flow.

As described above, the path calculation unit 15c may multiply the accommodation upper limit value by a parameter for adjustment to give relaxation so that a flow not accommodated is not generated.

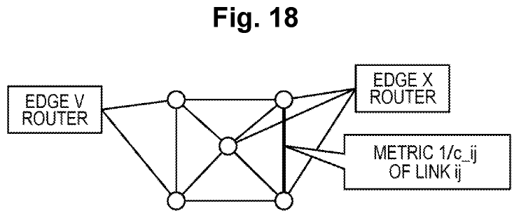

In addition, the path calculation unit 15c calculates a path of a flow not accommodated, by sequentially searching for the shortest path by Dijkstra's algorithm from the start point. In this case, as illustrated in FIG. 18, the path calculation unit 15c calculates a path with the reciprocal of a residual band c_i,j of the link i,j as a link metric. Accordingly, the larger the residual band, that is, the smaller the link utilization, the more preferentially the path including the link is selected.

In addition, the path calculation unit 15c instructs the controller to change the path on the basis of the determined path.

### [Traffic Engineering (TE) Processing]

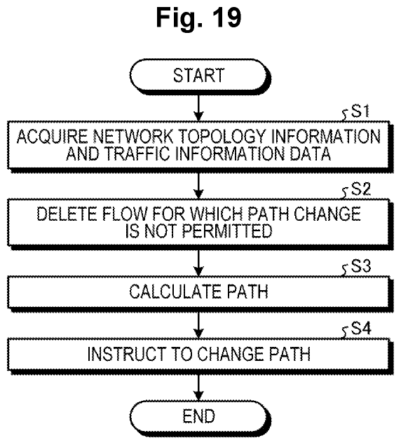

Next, FIG. 19 is a flowchart illustrating a procedure of the TE processing. The flowchart of FIG. 19 is started, for example, at a timing when a user gives an instruction to start the processing.

First, the acquisition unit 15a acquires the network topology information 14a and the traffic information data 14b by acquiring and analyzing AC traffic information from a collection device or the like that collects the AC traffic information (Step S1). The acquisition unit 15a stores the acquired network topology information 14a and traffic information data 14b in the storage unit 14.

Next, the preprocessing unit 15b receives an input designating a flow for which path change is not permitted, and deletes the designated flow from the traffic information data 14b (Step S2).

Next, the path calculation unit 15c calculates the path of each flow so that the number of flows whose paths are to be changed is minimized (Step S3). Specifically, the mathematical calculation unit 15d calculates the solutions of the linear programming problem formulated so that the number of flows whose paths are to be changed is minimized and the maximum link utilization is minimized. In addition, the path calculation unit 15c determines the path of each flow on the basis of the solutions of the linear programming problem obtained with respect to flow groups generated by grouping the flows in traffic.

For example, regarding flows branched in the optimal solution, the path calculation unit 15c considers flows that cannot be accommodated in line unit to be accommodated in VPN unit. In addition, the path calculation unit 15c considers flows that cannot be accommodated in VPN unit to be accommodated in user communication unit. In addition, the path calculation unit 15c calculates paths of flows that cannot be accommodated in user communication unit by Dijkstra's algorithm, and determines the paths.

In addition, the path calculation unit 15c instructs the controller to change the path on the basis of the determined path (Step S4). Accordingly, a series of TE processing ends.

### Second Embodiment

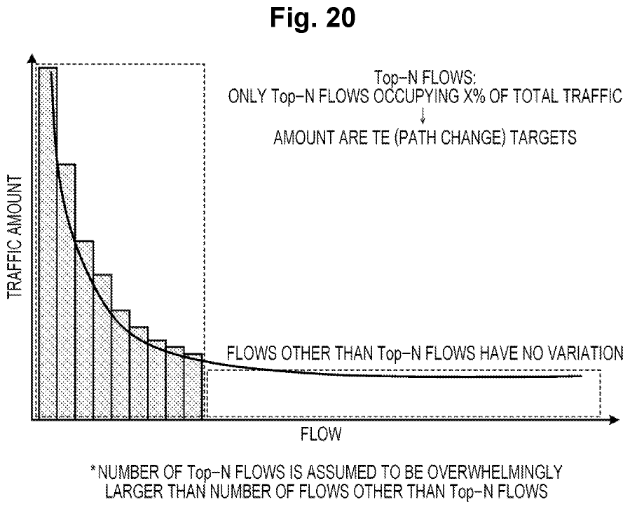

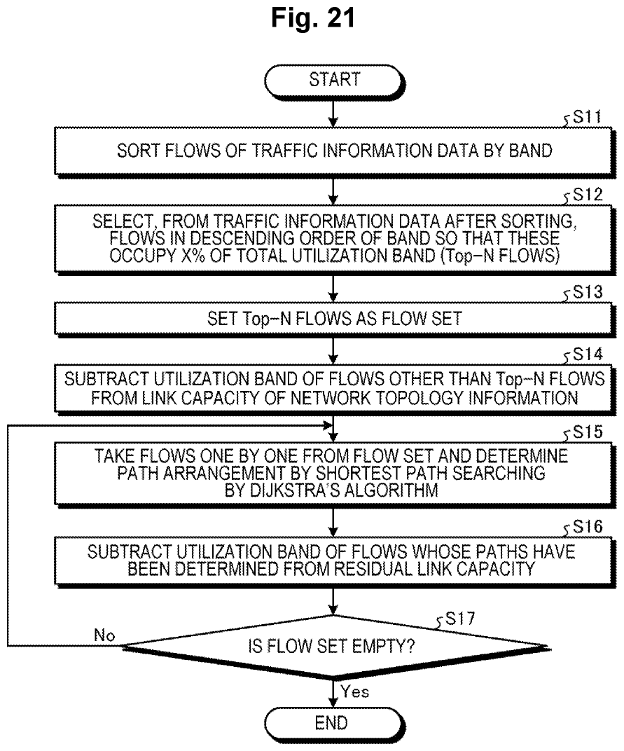

Here, FIGS. 20 and 21 are diagrams for explaining the processing by a TE device according to a second embodiment. Only differences from the TE processing by the TE device 10 according to the first embodiment will be described, and description of common points will be omitted.

In a TE device 10 according to the second embodiment, in a case where the sum of descending order of traffic amounts of flows occupies a predetermined ratio with respect to the total traffic amount, a path calculation unit 15c calculates the path of each of the flows. Specifically, as illustrated in FIG. 20, the path calculation unit 15c conducts the TE processing only for Top-N flows that are dominant with respect to the total traffic amount.

Here, the Top-N flows occupy a predetermined percentage of the total traffic amount. In this embodiment, no path change is performed for flows other than the Top-N flows. The number of Top-N flows is assumed to be overwhelmingly larger than the number of flows other than the Top-N flows. Therefore, the TE device 10 can suppress the number of flows whose parts are re-routed, while securing a sufficient optimization effect to some extent.

FIG. 21 illustrates a procedure of the TE processing according to the second embodiment. First, the path calculation unit 15c sorts flows of traffic information data 14b by the utilization band (Step S11).

In addition, the path calculation unit 15c selects the sorted Top-N flows of the traffic information data 14b. That is, the path calculation unit 15c selects the flows of the traffic information data 14b in descending order of the utilization band so that these occupy a predetermined X % of the total utilization band (Step S12). Here, X is a parameter managed by SG or the like.

The path calculation unit 15c sets the selected Top-N flows as a flow set to be processed thereafter (Step S13). In addition, the path calculation unit 15c subtracts the utilization band of the flows other than the Top-N flows from the link capacity of network topology information 14a (Step S14).

The path calculation unit 15c selects flows one by one from the flow set, and performs shortest path searching by Dijkstra's algorithm to determine the path arrangement (path) (Step S15). In this case, the path calculation unit 15c calculates the path with the reciprocal of a residual band c_ij of each link as a metric. In addition, the path calculation unit 15c subtracts the utilization band of the flows whose paths have been determined from the link capacity (Step S16).

In a case where the flow set is not empty (No in Step S17), the path calculation unit 15c returns the processing to Step S15. In a case where the flow set is empty (Yes in Step S17), the path calculation unit 15c completes a series of processing.

### Third Embodiment

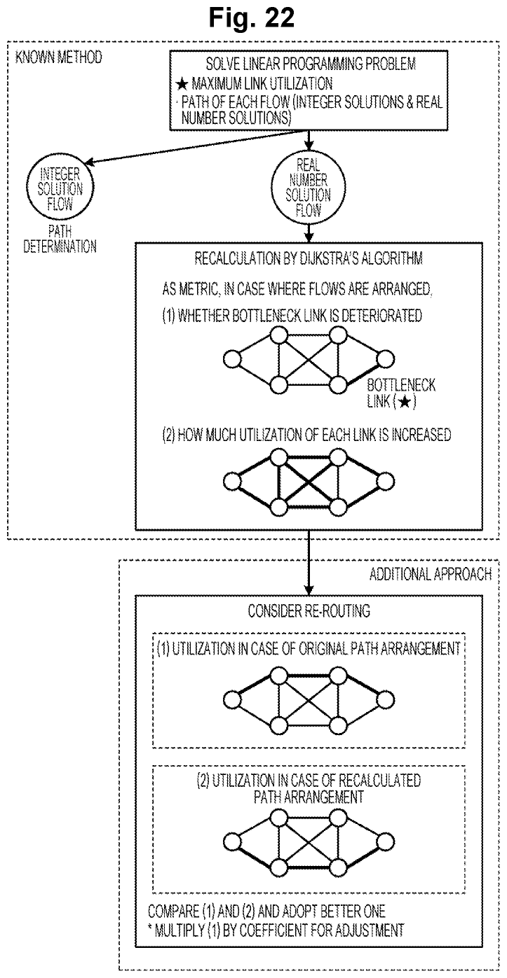

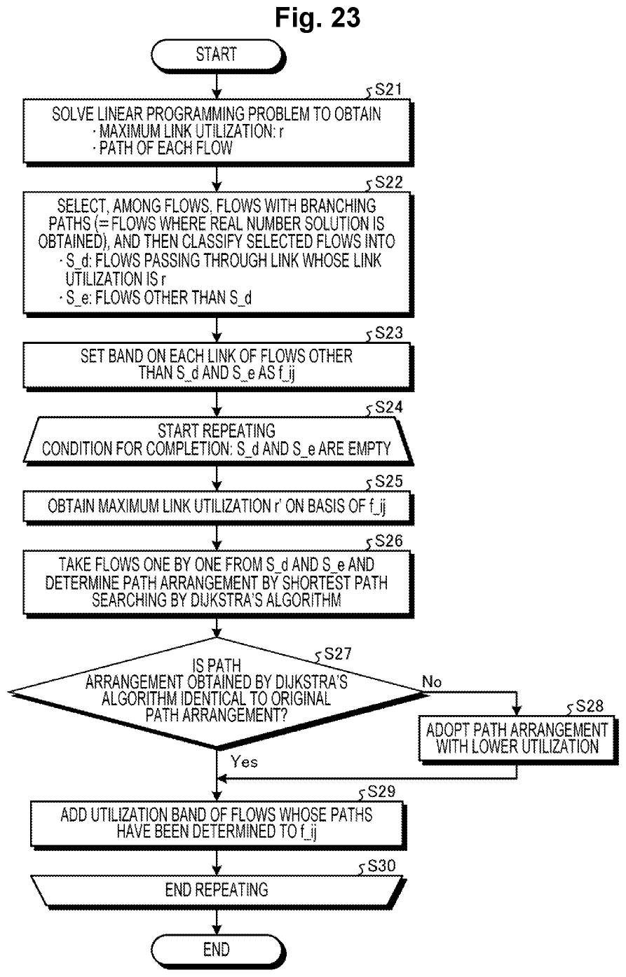

FIGS. 22 and 23 are diagrams for explaining the processing by a TE device according to a third embodiment. In a TE device 10 according to the third embodiment, a path calculation unit 15c calculates the path again by Dijkstra's algorithm with respect to real number solutions among the solutions calculated by a mathematical calculation unit 15d. Specifically, as illustrated in FIG. 22, a linear programming problem is solved by a known method, and then improvement is performed in consideration of re-routing. Specifically, first, a linear programming problem is solved to obtain a solution of a path of each flow so that the maximum link utilization is minimized.

Since the integer solution can be realized by the network device, the obtained path is determined. On the other hand, since it is difficult to realize the real number solution by the network device, the path calculation unit 15c performs recalculation by Dijkstra's algorithm. In that case, the path calculation unit 15c focuses on whether the bottleneck link is deteriorated as a link metric. In addition, the path calculation unit 15c focuses on how much the link utilization is increased. In addition, the link utilization in the original path arrangement (path) is compared with the link utilization in the recalculated path arrangement, and the path arrangement with the lower link utilization is adopted.

FIG. 23 illustrates a procedure of the TE processing according to the third embodiment. First, the mathematical calculation unit 15d solves a linear programming problem and obtains a maximum link utilization r and the path of each flow (Step S21).

The path calculation unit 15c selects, among the flows, flows with branching paths where a real number solution is obtained, and classifies the selected flows into S_d and S_e (Step S22). Here, S_d represents flows passing through a link whose link utilization is r, and S_e represents flows other than S_d. In addition, the band on each link of flows other than S_d and S_e where an integer solution is obtained is set as f_ij (Step S23), and the path is determined.

The path calculation unit 15c repeats the processing of Steps S25 to S29 (Step S30) until S_d and S_e are empty (Step S24).

First, the path calculation unit 15c obtains a maximum link utilization r′ on the basis of f_ij (Step S25). Next, the path calculation unit 15c selects flows one by one from S_d and S_e, and performs shortest path searching by Dijkstra's algorithm to determine the path arrangement (path) (Step S26). In this case, the metric of the link is expressed as Expression (1).

$$\begin{matrix}[ Math . 1 ] & \\ ( {f}_{ij} + flow ) / c\_ij + T 1 max \{ 0 , \frac{( {f}_{ij} + flow )}{{c}_{i j}} - {r}^{′} \} & ( 1 )\end{matrix}$$

### Here,

T1; parameter for adjustment
flow; band of flow
cᵢⱼ; link capacity

The path calculation unit 15c confirms whether the path arrangement obtained by Dijkstra's algorithm is identical to the original path arrangement (Step S27). In a case where they are not identical to each other (No in Step S27), the path arrangement with a lower utilization is adopted (Step S28), and the utilization band of the flows whose paths have been determined is added to f_ij (Step S29). In a case where they are identical to each other (Yes in Step S27), the processing proceeds to Step S29.

In a case where S_d and S_e are empty, the path calculation unit 15c completes a series of processing.

### OTHER EMBODIMENTS

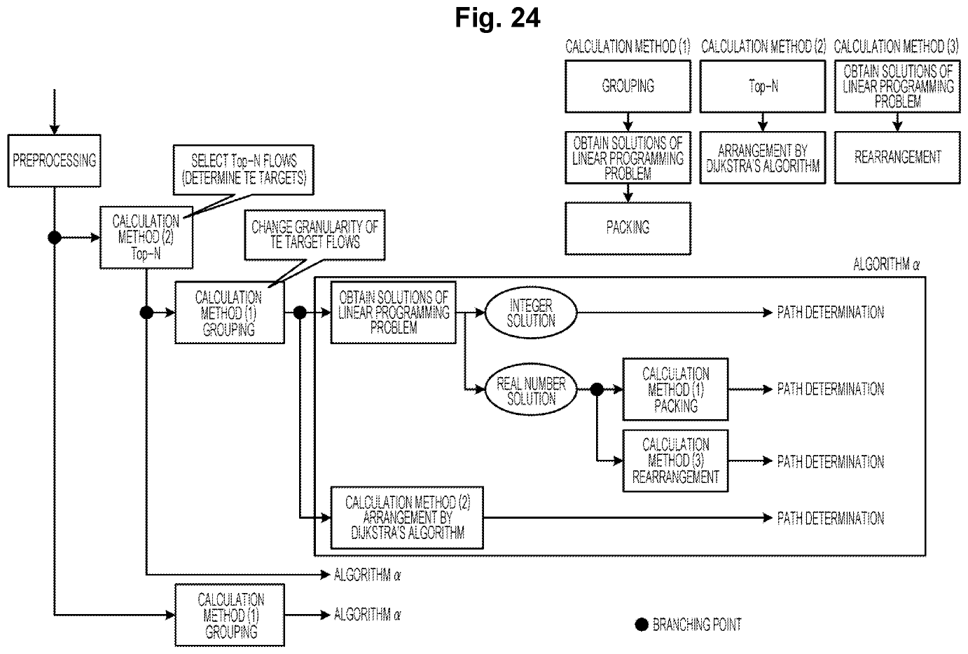

FIG. 24 is a diagram for explaining the processing by a TE device according to another embodiment. A TE device 10 may perform processing combining the processing of the first to third embodiments. In FIG. 24, a calculation method (1) means the processing of the first embodiment. In addition, a calculation method (2) means the processing of the second embodiment, and a calculation method (3) means the processing of the third embodiment.

Specifically, in the calculation method (1), as illustrated in FIG. 9, the grouping described in the first embodiment is performed to change the granularity of the TE targets, the solutions of the linear programming problem are obtained, and the packing problem is applied to the real number solutions. In the calculation method (2), as illustrated in FIG. 20, only the Top-N flow that is dominant with respect to the total traffic amount is selected as the TE processing target, and the flow arrangement is calculated by Dijkstra's algorithm. In the calculation method (3), as illustrated in FIG. 22, the solutions of the linear programming problem are obtained, and with respect to the real number solutions, rearrangement is performed in consideration of re-routing.

Then, as illustrated in FIG. 24, the TE device 10 can determine the path by combining the processing of the calculation methods (1) to (3). In this manner, it is possible to perform the TE processing while more efficiently suppressing re-routing by an optimum method according to the situation.

### Effects

As described above, in the TE device 10, the acquisition unit 15a acquires the network topology information 14a indicating the connection form of the network device and the traffic information data 14b that is information about flows in traffic. In addition, the path calculation unit 15c calculates the path of each flow so that the number of flows whose paths are to be changed is minimized.

Specifically, the mathematical calculation unit 15d calculates the solutions of the linear programming problem formulated so that the number of flows whose paths are to be changed is minimized and the maximum link utilization is minimized. In addition, the path calculation unit 15c determines the path of each flow on the basis of the solutions of the linear programming problem obtained with respect to flow groups generated by grouping the flows in traffic. Accordingly, it is possible to efficiently limit or suppress communication being a target of path change within a realistic time on the basis of flow information, an operation policy, or the like.

Alternatively, in a case where the sum of descending order of traffic amounts of flows occupies a predetermined ratio with respect to the total traffic amount, the path calculation unit 15c calculates the path of each of the flows. Accordingly, it is possible to efficiently limit or suppress communication being a target of path change within a realistic time on the basis of flow information, an operation policy, or the like.

Alternatively, the mathematical calculation unit 15d calculates the solutions of the linear programming problem formulated so that the number of flows whose paths are to be changed is minimized and the maximum link utilization is minimized. In addition, the path calculation unit 15c calculates the path again by Dijkstra's algorithm with respect to real number solutions among the solutions. Accordingly, it is possible to efficiently limit or suppress communication being a target of path change within a realistic time on the basis of flow information, an operation policy, or the like.

In addition, the preprocessing unit 15b deletes, from the traffic information data 14b that is the information about flows in traffic, information about a flow for which path change is not permitted. Accordingly, re-routing can be efficiently suppressed.

In addition, the preprocessing unit 15b adds at least any of an average value, a maximum value, and a minimum value of traffic amounts acquired at different times to the traffic information data 14b that is the information about flows in traffic. Accordingly, it is possible to effectively perform the TE processing by properly using the average value, the maximum value, or the minimum value as the band of each flow according to the availability of network resources or a policy.

### [Program]

It is also possible to produce a program that describes the processing executed by the TE device 10 according to the above embodiment in a computer executable language. In an embodiment, the TE device 10 can be implemented by installing a TE program for executing the TE processing as packaged software or online software in a desired computer. For example, an information processing device is caused to execute the TE program, thereby functioning as the TE device 10. In addition, the information processing device includes a mobile communication terminal such as a smartphone, a mobile phone, or a personal handyphone system (PHS) and a slate terminal such as a personal digital assistant (PDA). Further, the functions of the TE device 10 may be implemented on a cloud server.

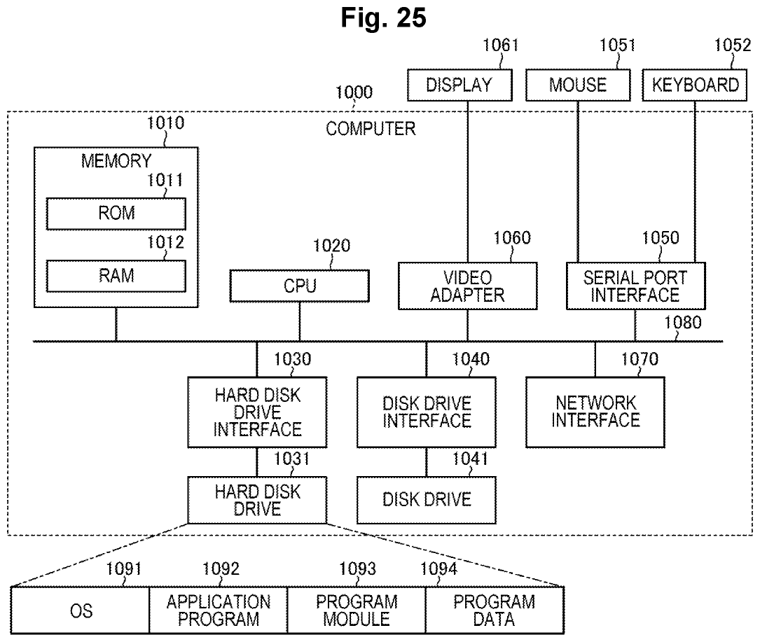

FIG. 25 is a diagram illustrating an example of a computer that executes the TE program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other via a bus 1080.

The memory 1010 includes a read-only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. The serial port interface 1050 is connected to, for example, a mouse 1051 and a keyboard 1052. The video adapter 1060 is connected to, for example, a display 1061.

Here, the hard disk drive 1031 stores, for example, an OS 1091, an application program 1092, a program module 1093, and program data 1094. Each piece of information described in the above embodiment is stored in, for example, the hard disk drive 1031 or the memory 1010.

In addition, the TE program is stored in the hard disk drive 1031 as the program module 1093 in which commands to be executed by the computer 1000 are described, for example. Specifically, the program module 1093 in which each type of processing performed by the TE device 10 described in the above embodiment is written is stored in the hard disk drive 1031.

Data used in information processing performed by the TE program is stored as the program data 1094 in the hard disk drive 1031, for example. The CPU 1020 reads, into the RAM 1012, the program module 1093 and the program data 1094 stored in the hard disk drive 1031 as necessary and executes each procedure described above.

The program module 1093 and the program data 1094 related to the TE program are not limited to being stored in the hard disk drive 1031, and may be stored in, for example, a removable storage medium and read by the CPU 1020 via the disk drive 1041 or the like. Alternatively, the program module 1093 and the program data 1094 related to the TE program may be stored in another computer connected via a network such as a local area network (LAN) or a wide area network (WAN) and may be read by the CPU 1020 via the network interface 1070.

Although the embodiments to which the present invention made by the present inventors is applied have been described above, the present invention is not limited by the description and the drawings of the present embodiments showing a part of the disclosure of the present invention. In other words, other embodiments, examples, operational techniques, and the like made by those skilled in the art or the like on the basis of the present embodiment are all included in the scope of the present invention.

### REFERENCE SIGNS LIST

10 TE device
13 Communication control unit
14 Storage unit
14a Network topology information
14b Traffic information data
15 Control unit
15a Acquisition unit
15b Preprocessing unit
15c Path calculation unit
15d Mathematical calculation unit

1. A traffic engineering device comprising:
an acquisition unit, comprising one or more processors, configured to acquire information indicating a connection form of a network device and information about flows in traffic; and
a path calculation unit, comprising one or more processors, configured to calculate a path of each flow so that the number of flows whose paths are to be changed is minimized.

2. The traffic engineering device according to claim 1, further comprising: a mathematical calculation unit, comprising one or more processors, configured to calculate solutions of a linear programming problem formulated so that the number of flows whose paths are to be changed is minimized and a maximum link utilization is minimized,
wherein the path calculation unit is configured to determine a path of each flow on the basis of the solutions of the linear programming problem obtained with respect to flow groups generated by grouping the flows in traffic.

3. The traffic engineering device according to claim 1, wherein in a case where the sum of descending order of traffic amounts of flows occupies a predetermined ratio with respect to a total traffic amount, the path calculation unit is configured to calculate a path of each of the flows.

4. The traffic engineering device according to claim 1, further comprising: a mathematical calculation unit configured to calculate solutions of a linear programming problem formulated so that the number of flows whose paths are to be changed is minimized and a maximum link utilization is minimized,
wherein the path calculation unit is configured to calculate a path again by Dijkstra's algorithm with respect to real number solutions among the solutions.

5. The traffic engineering device according to claim 1, further comprising a preprocessing unit, comprising one or more processors, configured to delete, from the information about the flows in traffic, information about a flow for which path change is not permitted.

6. The traffic engineering device according to claim 5, wherein the preprocessing unit is configured to add at least any of an average value, a maximum value, and a minimum value of traffic amounts acquired at different times to the information about the flows in traffic.

7. A traffic engineering method that is executed by a traffic engineering device, the method comprising:
acquiring information indicating a connection form of a network device and information about flows in traffic; and
calculating a path of each flow so that the number of flows whose paths are to be changed is minimized.

8. A non-transitory computer readable medium storing a program, wherein execution of the program causes a computer to execute:
acquiring information indicating a connection form of a network device and information about flows in traffic; and
calculating a path of each flow so that the number of flows whose paths are to be changed is minimized.
